(19) United States
(12) Patent Application Publication
(10) Pub. No.: US 2023/0271621 A1
(43) Pub. Date: Aug. 31, 2023

(54) DRIVING ASSISTANCE DEVICE, LEARNING DEVICE, DRIVING ASSISTANCE METHOD, MEDIUM WITH DRIVING ASSISTANCE PROGRAM, LEARNED MODEL GENERATION METHOD, AND MEDIUM WITH LEARNED MODEL GENERATION PROGRAM

(71) Applicant: Mitsubishi Electric Corporation, Tokyo (JP)

(72) Inventors: Mizuho WAKABAYASHI, Tokyo (JP); Hiroyoshi SHIBATA, Tokyo (JP); Takayuki ITSUI, Tokyo (JP); Shin MIURA, Tokyo (JP)

(73) Assignee: Mitsubishi Electric Corporation, Tokyo (JP)

(21) Appl. No.: 18/017,882

(22) PCT Filed: Aug. 27, 2020
(86) PCT No.: PCT/JP2020/032397

§ 371 Date: Jan. 25, 2023

(51) Int. Cl. B60W 50/14; B60W 40/02; B60W 50/06; G06N 5/04

(52) U.S. Cl. CPC B60W 50/14; B60W 40/02; B60W 50/06; G06N 5/04; B60W 2554/00; B60W 2530/00

(57) ABSTRACT

A driving assistance device includes processing circuitry configured to acquire object detection information indicating a detection result of an object around a vehicle by a sensor mounted on the vehicle, output driving assistance information from the input object detection information by using a learned model for driving assistance to infer the driving assistance information for assisting driving of the vehicle from the object detection information, calculate, as an evaluation value, a degree of influence of the input object detection information on an output of the learned model for driving assistance, and output the driving assistance information on a basis of the object detection information in which the calculated evaluation value is greater than a predetermined threshold among the input object detection information.

### TECHNICAL FIELD

The present invention relates to a driving assistance device, a learning device, a driving assistance method, a driving assistance program, a learned model generation method, and a learned model generation program.

### BACKGROUND ART

A technique of performing driving assistance on the basis of object detection information output from in-vehicle sensors has been developed. For example, in an automated vehicle, an action to be taken by the vehicle is determined on the basis of a detection result of an obstacle around the vehicle by the in-vehicle sensors, and vehicle control is executed. At that time, more appropriate vehicle control can be executed by determining the action of the vehicle on the basis of only the object that affects the control of the vehicle, instead of determining the action to be taken by the vehicle on the basis of all the objects detected by the in-vehicle sensors.

For example, the automated traveling system described in Patent Literature 1 detects only an object within a preset traveling area as an obstacle and controls a vehicle so as to avoid collision with the detected obstacle.

### CITATION LIST

### Patent Literature

Patent Literature 1: JP 2019-168888 A

### SUMMARY OF INVENTION

### Technical Problem

However, there is an object that does not need to be considered in determining the action of a vehicle even if it is an object traveling on the same road, such as a vehicle traveling on the right lane when a host vehicle changes lanes from the center lane to the left lane. Then, if the action is determined on the basis of the detection result of such an object, there is a possibility that an inappropriate action determination is made.

The present disclosure has been made in view of the above circumstances, and an object of the present disclosure is to obtain a driving assistance device capable of more appropriately assisting the driving of a vehicle on the basis of object detection information.

### Solution to Problem

A driving assistance device according to the present disclosure including an acquisition unit to acquire object detection information indicating a detection result of an object around a vehicle by a sensor mounted on the vehicle, an inference unit to output driving assistance information from the object detection information input from the acquisition unit by using a learned model for driving assistance to infer the driving assistance information for assisting driving of the vehicle from the object detection information, and an evaluation unit to calculate, as an evaluation value, a degree of influence of the object detection information input from the acquisition unit on an output of the learned model for driving assistance, wherein the inference unit outputs the driving assistance information on a basis of the object detection information in which the evaluation value calculated by the evaluation unit is greater than a predetermined threshold among the object detection information input from the acquisition unit.

### Advantageous Effects of Invention

The driving assistance device according to the present disclosure includes the inference unit to output the driving assistance information from the object detection information input from the acquisition unit by using the learned model for driving assistance to infer the driving assistance information for assisting driving of the vehicle from the object detection information, and the evaluation unit to calculate, as an evaluation value, the degree of influence of the object detection information input from the acquisition unit on the output of the learned model for driving assistance. The inference unit outputs the driving assistance information on the basis of the object detection information in which the evaluation value calculated by the evaluation unit is greater than a predetermined threshold among the object detection information input from the acquisition unit. Therefore, by outputting the driving assistance information on the basis of the object detection information having a large evaluation value, it is possible to more appropriately assist the driving of the vehicle on the basis of the object detection information.

### BRIEF DESCRIPTION OF DRAWINGS

FIG. 1 is a configuration diagram illustrating a configuration of an automated driving system 1000 according to a first embodiment.

FIG. 2 is a configuration diagram illustrating a configuration of a driving assistance device 100 according to the first embodiment.

FIG. 3 is a hardware configuration diagram illustrating a hardware configuration of the driving assistance device 100 according to the first embodiment.

FIG. 4 is a flowchart illustrating an operation of the driving assistance device 100 according to the first embodiment.

FIG. 5 is a conceptual diagram for explaining a specific example of first preprocessing.

FIG. 6 is a conceptual diagram for explaining the specific example of the first preprocessing.

FIG. 7 is a conceptual diagram for explaining a specific example of second preprocessing.

FIG. 8 is a diagram illustrating a specific example of an evaluation value.

FIG. 9 is a conceptual diagram for explaining the specific example of the second preprocessing.

FIG. 10 is a diagram illustrating a specific example of the evaluation value.

FIG. 11 is a conceptual diagram for explaining the specific example of the second preprocessing.

FIG. 12 is a configuration diagram illustrating a configuration of a learning device 300 according to the first embodiment.

FIG. 13 is a hardware configuration diagram illustrating a hardware configuration of the learning device 300 according to the first embodiment.

FIG. 14 is a flowchart illustrating an operation of the learning device 300 according to the first embodiment.

FIG. 15 is a flowchart for explaining an operation in which the learning device 300 according to the first embodiment performs initial learning of a learning model for driving assistance.

FIG. 16 is a flowchart for explaining an operation in which the learning device 300 according to the first embodiment learns a learning model for evaluation value calculation.

FIG. 17 is a flowchart for explaining an operation in which the learning device 300 according to the first embodiment relearns the learning model for driving assistance.

### DESCRIPTION OF EMBODIMENTS

### First Embodiment

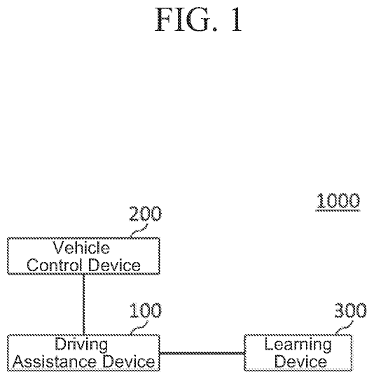

FIG. 1 is a configuration diagram illustrating a configuration of an automated driving system 1000 according to a first embodiment. The automated driving system 1000 includes a driving assistance device 100, a vehicle control device 200, and a learning device 300. Further, it is assumed that the automated driving system 1000 is provided in one vehicle. Details of the driving assistance device 100 and the vehicle control device 200 will be described in the following utilization phase, and details of the learning device 300 will be described in the following learning phase. The utilization phase is a phase in which the driving assistance device 100 assists the driving of a vehicle by using a learned model and the vehicle control device 200 controls the vehicle on the basis of driving assistance information output by the driving assistance device 100, whereas the learning phase is a phase in which the learning device 300 learns the learning model used by the driving assistance device 100 in the utilization phase.

<Utilization Phase>

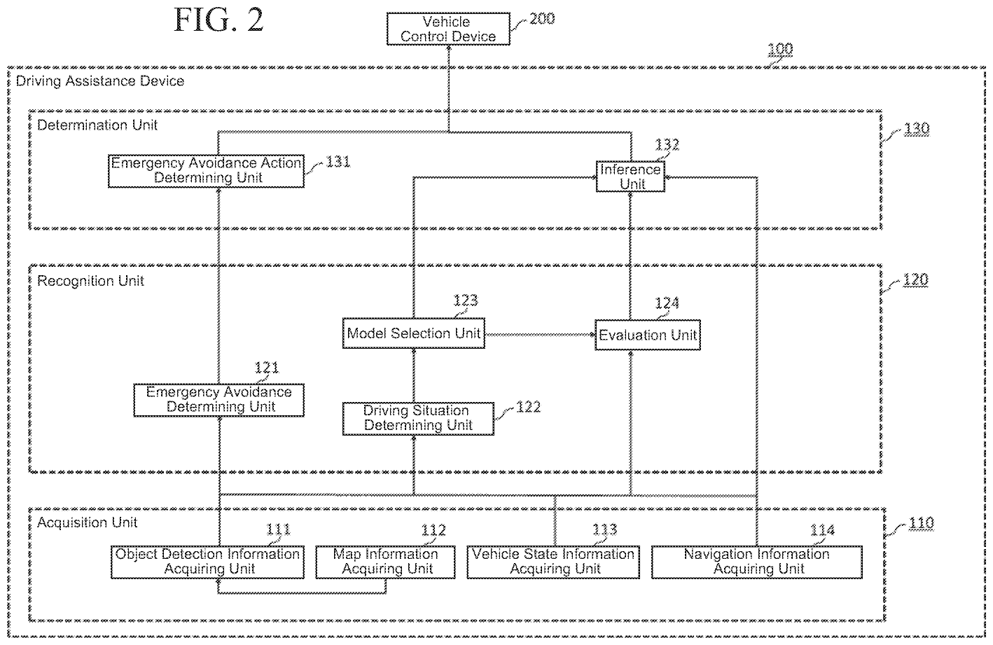

FIG. 2 is a configuration diagram illustrating a configuration of the driving assistance device 100 according to the first embodiment.

The driving assistance device 100 assists the driving of a vehicle by determining the behavior of the vehicle depending on the environment around the vehicle, and includes an acquisition unit 110, a recognition unit 120, and a determination unit 130. The driving assistance device 100 outputs driving assistance information to the vehicle control device 200, and the vehicle control device 200 controls the vehicle on the basis of the input driving assistance information.

The acquisition unit 110 acquires various types of information, and includes an object detection information acquiring unit 111, a map information acquiring unit 112, a vehicle state information acquiring unit 113, and a navigation information acquiring unit 114. The acquisition unit 110 outputs the acquired various types of information to the recognition unit 120 and the determination unit 130.

The object detection information acquiring unit 111 acquires object detection information indicating a detection result of an object around the vehicle. Here, the object detection information is sensor data acquired by a sensor mounted on the vehicle. For example, the object detection information acquiring unit 111 acquires point cloud data acquired by light detection and ranging (LiDAR), image data acquired by a camera, and chirp data acquired by a radar.

The object detection information acquiring unit 111 outputs the acquired object detection information to an emergency avoidance determining unit 121, an evaluation unit 124, and an inference unit 132. Here, after preprocessing the object detection information, the object detection information acquiring unit 111 outputs the preprocessed object detection information to the evaluation unit 124 and the inference unit 132. Hereinafter, the preprocessing performed on the object detection information by the object detection information acquiring unit 111 is referred to as “first preprocessing”. In addition, the object detection information output to the evaluation unit 124 and the inference unit 132 is the object detection information after the first preprocessing, but the object detection information output to the emergency avoidance determining unit 121 may be the object detection information after the first preprocessing or the object detection information before the first preprocessing.

Furthermore, in a case where information such as the position of the vehicle is required at the time of performing the first preprocessing, the object detection information acquiring unit 111 acquires vehicle state information from the vehicle state information acquiring unit 113 to be described later, and then performs the first preprocessing.

Hereinafter, the first preprocessing will be described.

The object detection information acquiring unit 111 specifies object detection information indicating a detection result of an object within a preset area on the basis of map information acquired by map information acquiring unit 112 to be described later. Then, the inference unit 132 to be described later outputs driving assistance information on the basis of the object detection information specified by the object detection information acquiring unit 111. Here, it is assumed that the above area is set by a designer of the driving assistance device 100 or a driver of the vehicle using an input device (not illustrated).

The first preprocessing will be described more specifically.

The object detection information acquiring unit 111 replaces a sensor value of object detection information indicating a detection result of an object outside the preset area with a predetermined sensor value on the basis of the map information. Here, as the predetermined sensor value, for example, a sensor value obtained when the sensor does not detect any object can be used. In addition, the object detection information acquiring unit 111 maintains the sensor value of the object detection information indicating the detection result of the object within the preset area at the original sensor value.

For example, in a case where a road on which the vehicle travels is set as a detection target area, the object detection information acquiring unit 111 replaces the sensor value of the object detection information indicating the detection result of the object outside the road on which the vehicle travels among the object detection information with the sensor value obtained when the sensor does not detect any object, and maintains the sensor value indicated by the object detection information indicating the detection result of the object within the road on which the vehicle travels at the original sensor value.

The map information acquiring unit 112 acquires map information indicating a position of a feature around the vehicle. Here, examples of the feature include a white line, a road shoulder edge, a building, and the like. The map information acquiring unit 112 outputs the acquired map information to the object detection information acquiring unit 111 and a driving situation determining unit 122.

The vehicle state information acquiring unit 113 acquires vehicle state information indicating the state of the vehicle. The state of the vehicle includes, for example, physical quantities such as a speed, an acceleration, a position, and a posture of the vehicle. Here, the vehicle state information acquiring unit 113 acquires vehicle state information indicating the position and speed of the vehicle calculated by, for example, a global navigation satellite system (GNSS) receiver or an inertial navigation device. The vehicle state information acquiring unit 113 outputs the acquired vehicle state information to the emergency avoidance determining unit 121, the driving situation determining unit 122, and the inference unit 132.

The navigation information acquiring unit 114 acquires navigation information indicating a travel plan of the vehicle such as a travel route to a destination and a recommended lane from a device such as a car navigation system. The navigation information acquiring unit 114 outputs the acquired navigation information to the driving situation determining unit 122.

The recognition unit 120 recognizes the situation around the vehicle on the basis of the information input from the acquisition unit 110, and includes the emergency avoidance determining unit 121, the driving situation determining unit 122, a model selection unit 123, and the evaluation unit 124.

The emergency avoidance determining unit 121 determines whether the vehicle is in a situation requiring emergency avoidance on the basis of the object detection information input from the acquisition unit 110. Here, the situation requiring emergency avoidance is, for example, a state where there is a high possibility of collision with another vehicle or a pedestrian, and the emergency avoidance determining unit 121 may calculate a distance to an obstacle on the basis of point cloud data, image data, or the like, and determine that it is a dangerous state if the calculated distance is equal to or less than a predetermined threshold.

The driving situation determining unit 122 determines the driving situation of the vehicle on the basis of the vehicle state information and the navigation information input from the acquisition unit 110. The driving situation here includes, for example, a lane change, a left turn at an intersection, a stop at a red light, and the like. For example, in a case where it is determined that the vehicle is approaching an intersection where the navigation information indicates a left turn on the basis of the position of the vehicle indicated by the vehicle state information and the position of the intersection indicated by the map information, the driving situation determining unit 122 determines that the driving situation of the vehicle is “left turn”.

The model selection unit 123 selects a learned model to be used by the evaluation unit 124 and the inference unit 132 on the basis of the driving situation determined by the driving situation determining unit 122. For example, in a case where the driving situation determined by the driving situation determining unit 122 is “lane change”, the learned model for a lane change is selected, whereas in a case where the driving situation determined by the driving situation determining unit 122 is “drive straight”, the learned model for drive straight is selected. Here, the model selection unit 123 selects a learned model for each of the learned model for evaluation value calculation and the learned model for driving assistance.

The evaluation unit 124 calculates, as an evaluation value, the degree of influence of the object detection information input from the acquisition unit 110 on the output of the learned model for driving assistance. Here, the evaluation value can also be understood as the degree of importance of each piece of object detection information on vehicle action determination. Furthermore, the learned model for driving assistance is a learned model used by the inference unit 132 to infer driving assistance information.

Moreover, in the first embodiment, the evaluation unit 124 outputs the evaluation value from the object detection information input from the acquisition unit by using a learned model for evaluation value calculation that calculates an evaluation value from object detection information. Here, the learned model for evaluation value calculation used by the evaluation unit 124 is the learned model for evaluation value calculation selected by the model selection unit 123.

An emergency avoidance action determining unit 131 outputs driving assistance information for the vehicle to perform emergency avoidance in a case where the emergency avoidance determining unit 121 determines that emergency avoidance is required. The emergency avoidance action determining unit 131 may infer the driving assistance information using AI or may determine the driving assistance information on a rule basis. For example, in a case where a pedestrian appears in front of the vehicle, emergency braking is performed. The details of the driving assistance information will be described in the following together with the inference unit 132.

The inference unit 132 outputs driving assistance information from the object detection information input from the acquisition unit 110 by using a learned model for driving assistance that infers driving assistance information for assisting the driving of the vehicle from object detection information. Here, the inference unit 132 outputs the driving assistance information on the basis of the object detection information in which the evaluation value calculated by the evaluation unit 124 is greater than a predetermined threshold among the object detection information input from the acquisition unit 110. In other words, the inference unit 132 outputs the driving assistance information not on the basis of the object detection information having an evaluation value smaller than the predetermined threshold. Furthermore, the learned model for driving assistance used by the inference unit 132 is the learned model for driving assistance selected by the model selection unit 123.

The driving assistance information output by the inference unit 132 indicates, for example, a control amount of the vehicle such as a throttle value, a brake value, and a steering value, a binary value indicating whether or not to change a lane, a timing to change a lane, a position and a speed of the vehicle at a future time, and the like.

In addition, the learned model for driving assistance uses at least the object detection information as an input, and is not limited to the one using only the object detection information as an input. Not only the object detection information but also other information, for example, vehicle state information may be used as an input of the learned model for driving assistance. More specifically, in the case of a model that infers lane change determination (that outputs whether to change a lane), since the relative speed relationship with another vehicle can be understood by using time series data as an input, the vehicle state information does not need to be used as an input. On the other hand, in the case of a model that infers a throttle value so as to maintain a distance before or after another vehicle, since an appropriate throttle value for maintaining the speed changes depending on the speed of the host vehicle, not only the object detection information but also the vehicle state information is used as an input of the model. Hereinafter, a case where both the object detection information and the vehicle state information are used as the input of the learned model for driving assistance will be described.

That is, the inference unit 132 outputs the driving assistance information from the vehicle state information and the object detection information input from the acquisition unit 110 by using the learned model for driving assistance that infers the driving assistance information from the vehicle state information and the object detection information.

Details of processing performed by the inference unit 132 will be described.

After preprocessing the object detection information input from the acquisition unit 110, the inference unit 132 inputs the preprocessed object detection information and the vehicle state information to the learned model for driving assistance. Hereinafter, the preprocessing performed on the object detection information by the inference unit 132 is referred to as “second preprocessing”.

Hereinafter, the second preprocessing will be described.

The inference unit 132 replaces the sensor value of the object detection information having an evaluation value equal to or less than a predetermined threshold among the object detection information input from the acquisition unit with a predetermined sensor value. Here, as the predetermined sensor value, for example, a sensor value obtained when the in-vehicle sensor does not detect any object can be used. In addition, the inference unit 132 replaces the sensor value of the object detection information having an evaluation value equal to or less than the predetermined threshold with the predetermined sensor value, and maintains the sensor value indicated by the object detection information having an evaluation value greater than the predetermined threshold at the original sensor value.

Then, the inference unit 132 outputs the driving assistance information by inputting the object detection information after the second preprocessing described above and the vehicle state information to the learned model for driving assistance.

The vehicle control device 200 controls the vehicle on the basis of the driving assistance information output from the driving assistance device 100. For example, in a case where the driving assistance information indicates a control amount of the vehicle, the vehicle control device 200 controls the vehicle to be driven with the control amount, and in a case where the driving assistance information indicates a vehicle state at a future time, the vehicle control device calculates a control amount of the vehicle for achieving the vehicle state, and controls the vehicle on the basis of the calculated control amount.

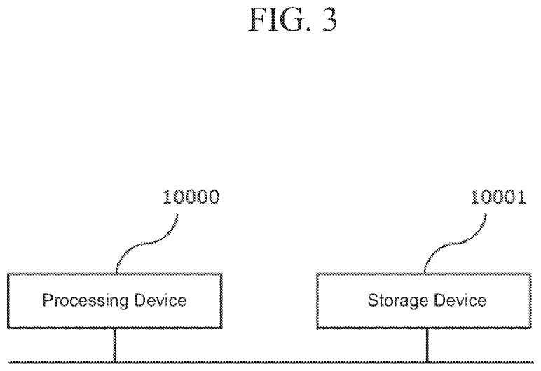

Next, the hardware configuration of the driving assistance device 100 according to the first embodiment will be described. Each function of the driving assistance device 100 is implemented by a computer. FIG. 3 is a configuration diagram illustrating a hardware configuration of a computer that implements the driving assistance device 100.

The hardware illustrated in FIG. 3 includes a processing device 10000 such as a central processing unit (CPU) and a storage device 10001 such as a read only memory (ROM) or a hard disk.

The acquisition unit 110, the recognition unit 120, and the determination unit 130 illustrated in FIG. 2 are implemented by the processing device 10000 executing a program stored in the storage device 10001. Furthermore, the method of implementing each function of the driving assistance device 100 is not limited to the combination of hardware and the program described above, and may be implemented by a single piece of hardware such as a large scale integrated circuit (LSI) in which a program is implemented in a processing device, or some of the functions may be implemented by dedicated hardware and some of the functions may be implemented by a combination of a processing device and a program.

The driving assistance device 100 according to the first embodiment is configured as described above.

Next, the operation of the driving assistance device 100 according to the first embodiment will be described.

Hereinafter, it is assumed that the object detection information used for the input of the learned model by the inference unit 132 and the evaluation unit 124 is point cloud data, and the emergency avoidance determining unit 121 determines whether emergency avoidance is required on the basis of image data and the point cloud data.

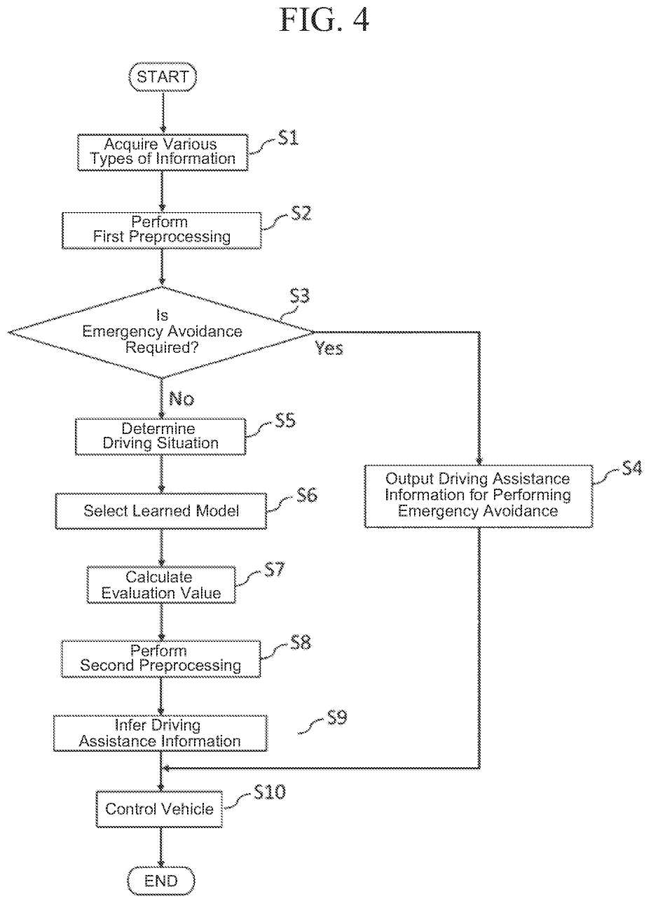

FIG. 4 is a flowchart illustrating the operation of the driving assistance device 100 according to the first embodiment. The operation of the driving assistance device 100 corresponds to a driving assistance method, and a program causing a computer to perform the operation of the driving assistance device 100 corresponds to a driving assistance program. Furthermore, “unit” may be appropriately read as “step”.

First, in step S1, the acquisition unit 110 acquires various types of information including object detection information. More specifically, the object detection information acquiring unit 111 acquires object detection information, the map information acquiring unit 112 acquires map information around a vehicle, the vehicle state information acquiring unit 113 acquires vehicle state information at the current time, and the navigation information acquiring unit 114 acquires navigation information indicating a travel plan of the host vehicle.

Next, in step S2, the acquisition unit 110 performs first preprocessing.

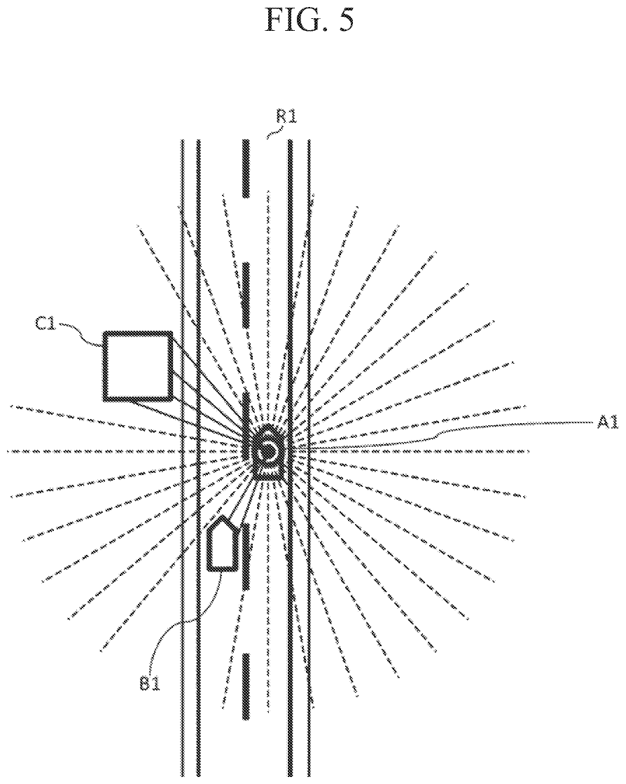

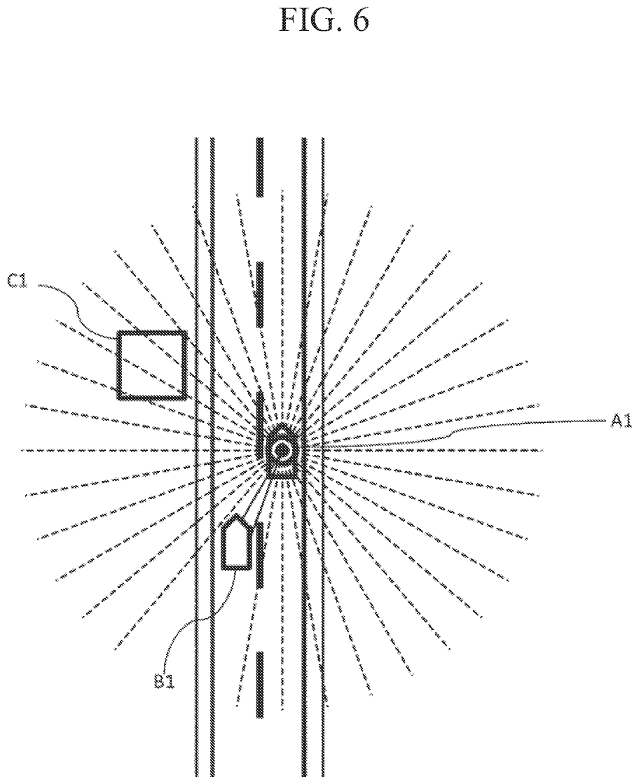

A specific example of the first preprocessing will be described with reference to FIGS. 5 and 6. FIGS. 5 and 6 are conceptual diagrams for explaining the specific example of the first preprocessing. A vehicle A1 is a host vehicle including the driving assistance device 100. In FIGS. 5 and 6, a straight line radially drawn from the center of the vehicle A1 represents each piece of object detection information, and the end position of the straight line represents a sensor value. Here, in a case where the sensor detects an object, the sensor value indicates a distance between the vehicle and the object, and in a case where the sensor detects nothing, the sensor value indicates a maximum distance that can be detected by the sensor. In addition, in a case where there is an object within the maximum detection distance of the sensor, it is assumed that the sensor detects the object.

In FIG. 5, the vehicle A1 is traveling on a road R1, and the LiDAR mounted on the vehicle A1 detects a building Cl outside the road R1 and another vehicle B1 traveling on the same road R1. In FIG. 5, among the object detection information, the object detection information in which nothing is detected is indicated by a dotted line, and the object detection information in which an object is detected is indicated by a solid line.

Here, since the vehicle A1 is traveling on the road R1, the object detection information necessary for controlling the vehicle A1 is the object detection information in which the object inside the road R1 is detected, and the road R1 is set as the setting area in the first preprocessing. In this case, the object detection information acquiring unit 111 replaces the sensor value of the object detection information in which the object outside the road R1 is detected with a predetermined value, and maintains the sensor value of the object detection information in which the object inside the road R1 is detected at the original sensor value. That is, as illustrated in FIG. 6, the object detection information acquiring unit 111 replaces the sensor value of the object detection information in which the building Cl outside the road R1 is detected with the sensor value obtained when the sensor does not detect any object.

Next, in step S3, the emergency avoidance determining unit 121 determines whether the vehicle is in a state requiring emergency avoidance. If the emergency avoidance determining unit 121 determines that the vehicle is in a state requiring emergency avoidance, the process proceeds to step S4, whereas it is determined that the vehicle is not in a state requiring emergency avoidance, the process proceeds to step S5.

If the process proceeds to step S4, the emergency avoidance action determining unit 131 outputs driving assistance information for performing emergency avoidance to the vehicle control device 200.

If the process proceeds to step S5, the driving situation determining unit 122 determines the driving situation of the vehicle.

Next, in step S6, the model selection unit 123 selects a learned model to be used in a subsequent step on the basis of the driving situation determined in step S5.

Next, in step S7, the evaluation unit 124 calculates, as an evaluation value, the degree of influence of the input object detection information on the output of the learned model for driving assistance.

Next, in step S8, the inference unit 132 outputs the driving assistance information on the basis of the vehicle state information at the current time and the object detection information in which the evaluation value calculated in step S7 is greater than the predetermined threshold among the object detection information.

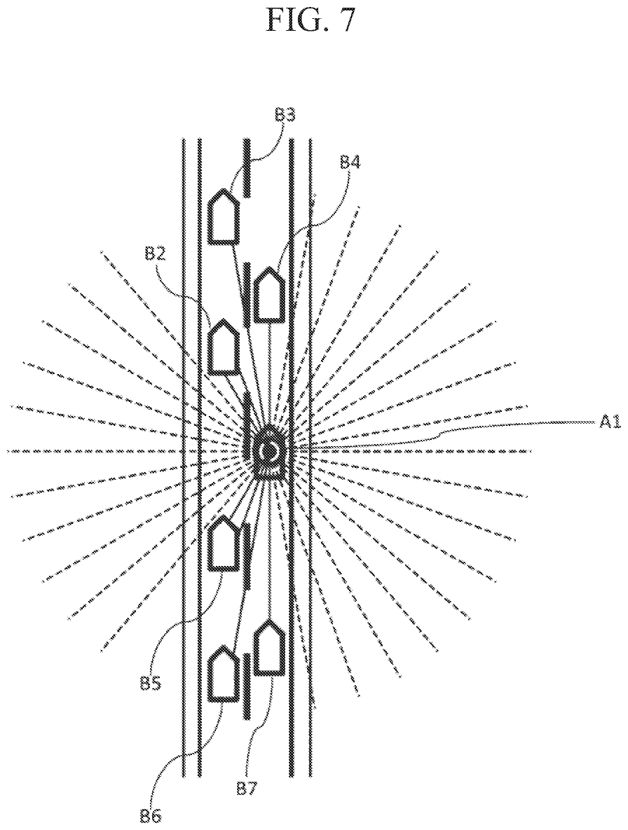

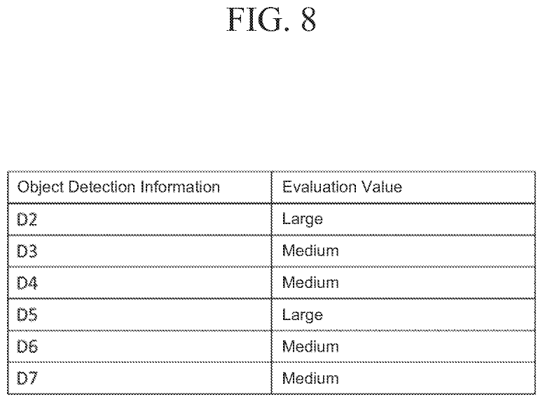

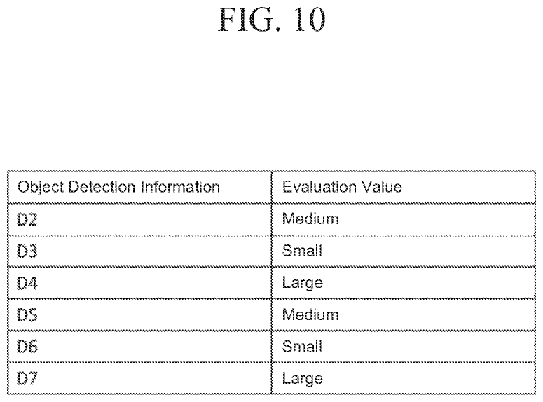

Specific examples of the operations of the evaluation unit 124 and the inference unit 132 will be described with reference to FIGS. 7 to 11. FIGS. 7, 9, and 11 are conceptual diagrams for explaining the specific examples of the operations of the evaluation unit 124 and the inference unit 132, whereas FIGS. 8 and 10 are diagrams illustrating specific examples of evaluation values calculated by the evaluation unit 124.

In FIG. 7, the in-vehicle sensor mounted on the vehicle A1 detects other vehicles B2 to B7.

Hereinafter, two cases, that is, (1) a case where the vehicle A1 changes lanes from the right lane to the left lane and (2) a case where the vehicle A1 continues to travel straight on the right lane will be described.

(1) Case where Vehicle A1 Changes Lanes from Right Lane to Left Lane

The evaluation value calculated by the evaluation unit 124 in this case will be described with reference to FIGS. 7 and 8. Since the other vehicle B4 and the other vehicle B7 are in the same lane, the importance in the lane change is not so high, in other words, it can be said that the degree of influence on the output of the learned model for driving assistance is medium. Therefore, the evaluation values of object detection information D5 in which the vehicle B4 is detected and object detection information in which the vehicle B7 is detected are calculated to be medium. In addition, since the other vehicle B3 and the other vehicle B6 are in the left lane but are distant from the host vehicle, the importance of the other vehicle B3 and the other vehicle B6 is not so high, and the evaluation values of object detection information D3 in which the vehicle B3 is detected and object detection information D6 in which the vehicle B6 is detected are calculated to be medium. On the other hand, since the other vehicle B2 and the other vehicle B5 are in the lane of the lane change destination and are close in distance to the host vehicle, the importance of object detection information D2 in which the vehicle B2 is detected and object detection information D5 in which the vehicle B5 is detected is high, and the evaluation values of these pieces of object detection information are calculated to be large.

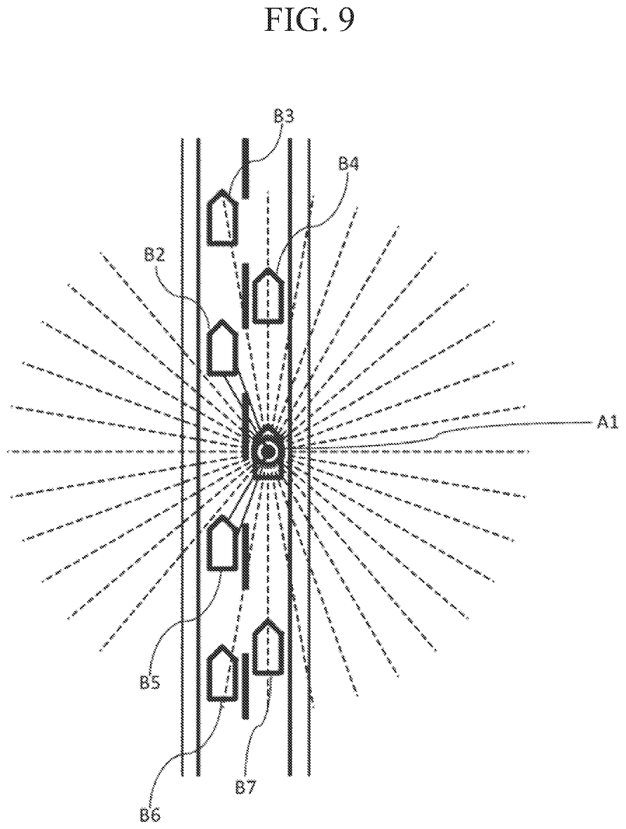

Then, the inference unit 132 performs the second preprocessing on the basis of the calculated evaluation values. For example, in a case where the threshold is set to a value between a medium value and a large value in FIG. 8, as illustrated in FIG. 9, the inference unit 132 replaces the sensor values of the object detection information D3, D4, D6, and D7 having a medium evaluation value with the sensor value obtained when the sensor does not detect any object. On the other hand, the inference unit 132 maintains the sensor values of the object detection information D2 and D5 having a large evaluation value at the original sensor values.

(2) Case where Vehicle A1 Continues to Travel Straight on Right Lane

The evaluation value calculated by the evaluation unit 124 in this case will be described with reference to FIGS. 7 and 10. Since the other vehicles B2 and B5 are traveling in the lane different from that of the vehicle A1, the importance of the other vehicles B2 and B5 when traveling straight is not so high, and the evaluation values of the object detection information D2 in which the vehicle B2 is detected and the object detection information D5 in which the vehicle B5 is detected are calculated to be medium. In addition, since the other vehicles B3 and B6 are traveling in the lane different from that of the vehicle A1 and are distant from the vehicle A1, the importance of the other vehicles B3 and B6 is low, and the evaluation values of the object detection information D3 in which the vehicle B3 is detected and the object detection information D6 in which the vehicle B6 is detected are calculated to be small. On the other hand, since the other vehicles B4 and B7 are traveling in the same lane as the vehicle A1, the importance of the other vehicles B4 and B7 is high, and the evaluation values of the object detection information D4 in which the vehicle B4 is detected and the object detection information D7 in which the vehicle B7 is detected are calculated to be large.

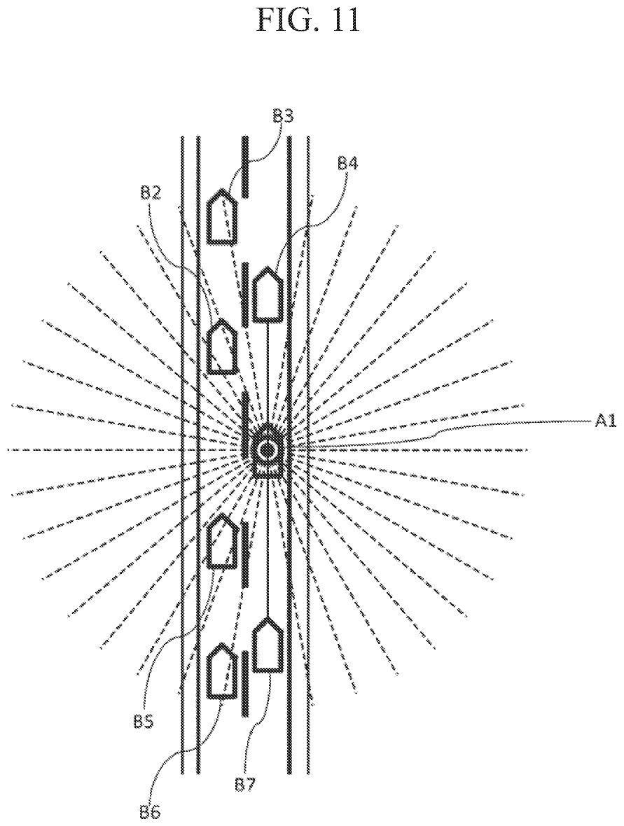

Then, the inference unit 132 performs the second preprocessing on the basis of the calculated evaluation values. For example, in a case where the threshold is set to a value between a medium value and a large value in FIG. 10, as illustrated in FIG. 11, the inference unit 132 replaces the sensor values of the object detection information D2, D3, D5, and D6 having a medium or small evaluation value with the sensor value obtained when the sensor does not detect any object. On the other hand, the inference unit 132 maintains the sensor values of the object detection information D4 and D7 having a large evaluation value at the original sensor values.

The processing performed by the evaluation unit 124 and the inference unit 132 has been described above, and the continuation of the flowchart in FIG. 4 will be described.

Next, in step S9, the vehicle control device 200 controls the vehicle on the basis of the action determination result output by the inference unit 132 in step S8.

With the operation as described above, the driving assistance device 100 according to the first embodiment can more appropriately assisting the driving of the vehicle on the basis of object detection information by outputting driving assistance information on the basis of object detection information having a large evaluation value. That is, there is a possibility that the inference accuracy decreases when unnecessary information is input to a learned model, but since the driving assistance device 100 calculates an evaluation value, inputs object detection information having a large evaluation value to the learned model, and reduces the input of unnecessary information, so that the inference accuracy of the learned model can be improved.

In addition, various obstacles such as other vehicles, buildings, pedestrians, and signs are present in a real road at various distances. Therefore, if the evaluation value is calculated on a rule basis, it takes a lot of time and effort to adjust the rule. However, since the driving assistance device 100 according to the first embodiment calculates the evaluation value by using the learned model for evaluation value calculation, it is possible to reduce labor required for calculating the evaluation value.

In addition, since the driving assistance device 100 specifies the object detection information indicating the detection result of the object within the preset area on the basis of the map information and outputs the driving assistance information on the basis of the specified object detection information, it is possible to improve the inference accuracy by reducing unnecessary information and performing inference only on the basis of information necessary for driving.

Moreover, the driving assistance device 100 performs the first preprocessing of replacing the sensor value of the object detection information indicating the detection result of the object outside the preset area with a predetermined sensor value on the basis of the map information, and outputs the object detection information after the first preprocessing to the evaluation unit 124 and the inference unit 132. Therefore, it is possible to reduce the influence of the detection result of the object outside the preset area on the inference. Furthermore, in this case, by setting the predetermined sensor value to a sensor value obtained when the sensor does not detect any object, the influence of the detection result of the object outside the area on the inference can be ignored. In addition, in the first preprocessing, since the sensor value of the object detection information indicating the detection result of the object within the area is maintained at the original sensor value, for example, driving assistance can be inferred in consideration of the influence of the object within the same road.

Furthermore, the driving assistance device 100 performs the second preprocessing of replacing the sensor value of the object detection information having an evaluation value equal to or less than a predetermined threshold among the object detection information input from the acquisition unit 110 with a predetermined sensor value, inputs the object detection information after the second preprocessing to the learned model for driving assistance, and outputs the driving assistance information. Therefore, it is possible to reduce the influence of the detection result of the object having an evaluation value equal to or less than the predetermined threshold on the inference. Furthermore, in this case, by setting the predetermined sensor value to the sensor value obtained when the sensor does not detect any object, the influence of the detection result of the object having an evaluation value equal to or less than the predetermined threshold on the inference can be ignored. In addition, in the second preprocessing, since the sensor value of the object detection information having an evaluation value greater than the predetermined threshold is maintained at the original sensor value, driving assistance can be inferred in consideration of the influence of the object having a large evaluation value.

Although learning of a learning model will be described in the learning phase, in some cases, learning data is generated by a driving simulator. However, since it is difficult for the driving simulator to completely reproduce the environment outside the road, there is a possibility that a difference occurs between the object detection information generated by the driving simulator and the object detection information in the real environment.

In order to solve this problem, the driving assistance device 100 according to the first embodiment specifies the object detection information indicating the detection result of the object within the preset area on the basis of the map information, and outputs the driving assistance information on the basis of the specified object detection information. Therefore, by ignoring the presence of the object outside the road, the object detection information obtained in the simulator environment is equivalent to the object detection information in the real environment. That is, by reducing the difference between the learning data generated by the driving simulator and the object detection information in the real environment, the inference accuracy of the learned model can be improved.

The utilization phase has been described above, and the learning phase will be described next.

<Learning Phase>

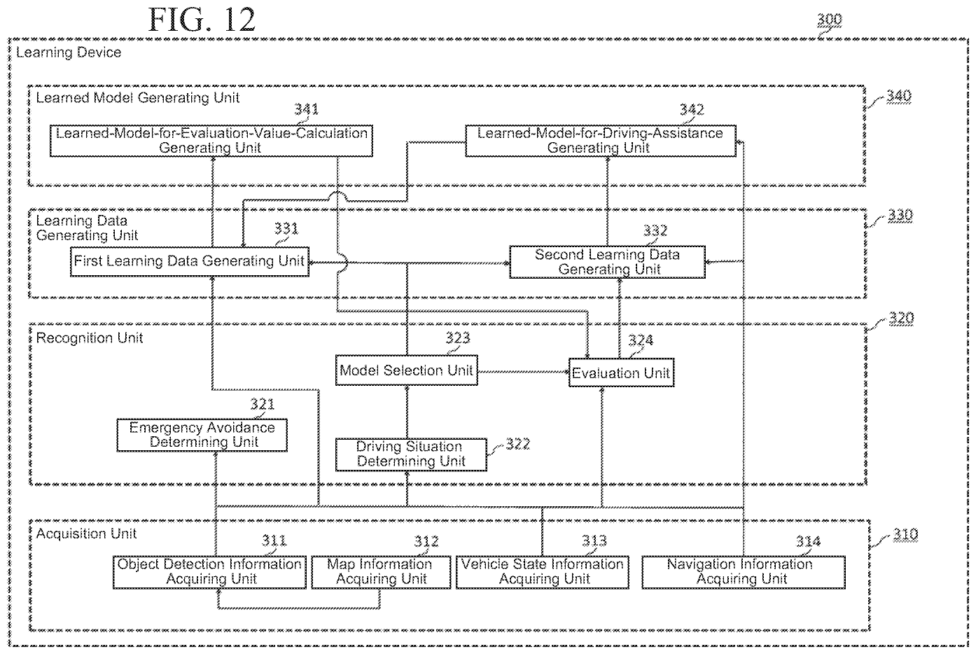

The learning phase for generating a learned model used in the utilization phase will be described. FIG. 12 is a configuration diagram illustrating a configuration of the learning device 300 according to the first embodiment.

The learning device 300 learns a learning model and generates a learned model used by the driving assistance device 100, and includes an acquisition unit 310, a recognition unit 320, a learning data generating unit 330, and a learned model generating unit 340.

The acquisition unit 310 acquires various types of information, and is similar to the acquisition unit 110 included in the driving assistance device 100. Like the acquisition unit 110, the acquisition unit 310 includes an object detection information acquiring unit 311, a map information acquiring unit 312, a vehicle state information acquiring unit 313, and a navigation information acquiring unit 314. Note that, however, the various types of information acquired by the acquisition unit 310 may be information acquired by an actually traveling vehicle as in the utilization phase, or may be information acquired by a driving simulator that virtually achieves the traveling environment of the vehicle.

The recognition unit 320 includes an emergency avoidance determining unit 321, a driving situation determining unit 322, a model selection unit 323, and an evaluation unit 324.

Like the emergency avoidance determining unit 121, the emergency avoidance determining unit 321 determines the necessity of emergency avoidance. In a case where the emergency avoidance determining unit 321 determines that emergency avoidance is required, the vehicle state information and the object detection information at that time are excluded from learning data.

Like the driving situation determining unit 122, the driving situation determining unit 322 determines the driving situation of the vehicle.

Like the model selection unit 123, the model selection unit 323 selects a learning model corresponding to the driving situation determined by the driving situation determining unit 322. The learning data generating unit 330 to be described later generates learning data of the learning model selected by the model selection unit 323, and the learned model generating unit 340 learns the learning model selected by the model selection unit 323. Here, in a case where the learning model for driving assistance is learned, the model selection unit 323 selects a learning model for driving assistance corresponding to the driving situation, and in a case where the learning model for evaluation value calculation is learned, the model selection unit selects a learning model for evaluation value calculation corresponding to the driving situation and a learned model for driving assistance in which initial learning is completed. In addition, in a case where the learning model for driving assistance is relearned, the model selection unit 323 selects a learning model for driving assistance to be relearned and a learned model for evaluation value calculation.

Like the evaluation unit 124, the evaluation unit 324 calculates the evaluation value of the object detection information input from the acquisition unit 310 by using the learned model for evaluation value calculation generated by a learned model for evaluation value calculation generating unit 341.

The learning data generating unit 330 generates learning data used for learning a learning model, and includes a first learning data generating unit 331 and a second learning data generating unit 332.

The first learning data generating unit 331 generates first learning data including object detection information indicating the detection result of an object around the vehicle by a sensor mounted on the vehicle and an evaluation value indicating the degree of influence of the object detection information on the output of a learned model for driving assistance that infers driving assistance information for assisting the driving of the vehicle. Here, the first learning data is learning data used for learning the learning model for evaluation value calculation.

The first learning data generating unit 331 generates a set of the object detection information and the evaluation value as the first learning data. Hereinafter, details of a method of generating the first learning data will be described.

For the generation of the first learning data, for example, as in the following Literature 1, the machine learning method capable of inferring which input value of a plurality of input values is emphasized by a learning model is adopted, and a set of an input value and an evaluation value of the learning model is obtained.

Literature 1
Daniel Smilkov, Nikhil Thorat, Been Kim, Fernanda Viegas, Martin Wattenberg, “SmoothGrad: removing noise by adding noise”

Originally, these techniques are techniques for visualizing a determination basis of a learning model, that is, AI so as to be interpreted by a human. For example, in image classification using a neural network, by quantifying and visualizing which value among pixel values of an image, which are input values, affects the determination of the neural network (which class the image belongs to), it is possible to know which part of the image the AI has used to determine the determination. In the present invention, values obtained by quantifying the determination basis of AI obtained by these techniques are utilized. As the determination basis of AI is quantified and regarded as the evaluation value of the input value, it can be considered that the input value having a low evaluation value is unnecessary for the determination of AI.

A specific example of the method of generating the first learning data will be described. First, the input and output relationship of a learned model for driving assistance is expressed by Formula 1. Here, it is assumed that the functional form of f is defined by the designer of the learning model for driving assistance, and the value of each parameter included in f has already been determined by learning a learning model for driving assistance.

[Formula 1]

y=f(x) (1)

Here, the sensor value indicated by object detection information used as an input is represented by the vector of Formula 2, and the output value of the learned model for driving assistance is represented by the vector of Formula 3.

[Formula 2]

x=(x₁,x₂, . . . ,x_{L}) (2)

[Formula 3]

y=(y₁,y₂, . . . ,y_{M}) (3)

An evaluation value s(xᵢ) of an input value xᵢ (one element of input vector) is calculated from the learned model for driving assistance as in Formula 4.

$$\begin{matrix}[ Formula 4 ] & \\ s ( {x}_{i} ) = ‖ \frac{\partial f}{\partial {x}_{i}} ‖ & ( 4 )\end{matrix}$$

In Formula 4, double line parentheses on the right side mean a norm. The first learning data generating unit 331 obtains the evaluation value of input data x¹=[x₁, x₂, . . . , x_{L}] as s¹=[s(x₁), s(x₂), . . . , s(x_{L}))] using Formula 4. Here, the index on the upper right is not a power index but a label for distinguishing input data. Then, the first learning data generating unit 331 generates a plurality of pieces of teaching data s¹, s², . . . , and s^{N} by using a plurality of pieces of learning input data x¹, x², . . . , and x^{N}, and acquires the first learning data (set of input data and teaching data) as {x¹, s¹}, {x², s²}, . . . , and {x^{N}, s^{N}}.

The second learning data generating unit 332 generates second learning data including object detection information indicating the detection result of an object around the vehicle by the sensor mounted on the vehicle and driving assistance information for assisting the driving of the vehicle. Here, the second learning data is learning data used for learning a learning model for driving assistance.

Here, as a matter of course, in a case where the learning model for driving assistance uses information other than the object detection information as an input, the second learning data generating unit 332 includes not only the object detection information but also other information, for example, vehicle state information, in the second learning data. Hereinafter, in accordance with the inference unit 132 described in the inference phase, it is assumed that the second learning data generating unit 332 generates the second learning data including the vehicle state information, the object detection information, and the driving assistance information.

The second learning data generating unit 332 generates a set of vehicle state information, object detection information, and driving assistance information as the second learning data. For example, the second learning data generating unit 332 may generate a set of vehicle state information and object detection information at time t and a control amount of the vehicle at time t+ΔT as the second learning data.

The learned model generating unit 340 learns a learning model and generates a learned model, and includes the learned model for evaluation value calculation generating unit 341 and a learned model for driving assistance generating unit 342.

The learned model for evaluation value calculation generating unit 341 generates a learned model for evaluation value calculation that calculates an evaluation value from the object detection information using the first learning data. In the first embodiment, the learned model for evaluation value calculation generating unit 341 generates the learned model for evaluation value calculation by so-called supervised learning using the first learning data in which the object detection information and the evaluation value form a set.

The learned model for driving assistance generating unit 342 generates a learned model for driving assistance that infers driving assistance information from the object detection information using the second learning data. Here, as mentioned in the description of the configurations of the inference unit 132 and the second learning data generating unit 332, the learned model for driving assistance uses at least the object detection information as an input, and in addition to the object detection information, other information, for example, vehicle state information may also be used as an input. Hereinafter, a case where the learned model for driving assistance generating unit 342 generates a learned model for driving assistance that infers driving assistance information from the vehicle state information and the object detection information using the second learning data will be described.

In addition, the learned model for driving assistance generating unit 342 generates the learned model for driving assistance using second learning data including object detection information in which the evaluation value calculated by the evaluation unit 324 is greater than a predetermined threshold among the second learning data input from the second learning data generating unit. Hereinafter, a case where the learned model for driving assistance is generated by supervised learning using second learning data in which vehicle state information and object detection information at the time t and the control amount of the vehicle at the time t+ΔT form a set will be described. However, a reward may be set for each driving situation, and the learned model for driving assistance may be generated by reinforcement learning.

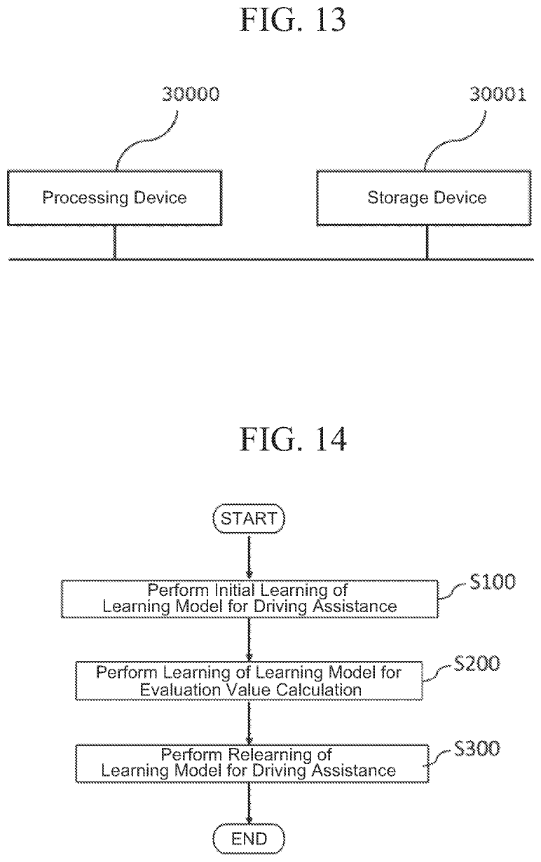

Next, the hardware configuration of the learning device 300 according to the first embodiment will be described. Each function of the learning device 300 is implemented by a computer. FIG. 13 is a configuration diagram illustrating a hardware configuration of a computer that implements the learning device 300.

The hardware illustrated in FIG. 13 includes a processing device 30000 such as a central processing unit (CPU) and a storage device 30001 such as a read only memory (ROM) or a hard disk.

The acquisition unit 310, the recognition unit 320, the learning data generating unit 330, and the learned model generating unit 340 illustrated in FIG. 12 are implemented by the processing device 30000 executing a program stored in the storage device 30001. Furthermore, the method of implementing each function of the learning device 300 is not limited to the combination of hardware and the program described above, and may be implemented by a single piece of hardware such as a large scale integrated circuit (LSI) in which a program is implemented in a processing device, or some of the functions may be implemented by dedicated hardware and some of the functions may be implemented by a combination of a processing device and a program.

The learning device 300 according to the first embodiment is configured as described above.

Next, the operation of the learning device 300 according to the first embodiment will be described.

FIG. 14 is a flowchart illustrating the operation of the learning device 300 according to the first embodiment. The operation of the learning device 300 corresponds to a method of generating a learned model, and the program causing a computer to perform the operation of the learning device 300 corresponds to a learned model generation program. Furthermore, “unit” may be appropriately read as “step”.

The operation of the learning device 300 is divided into three stages, that is, initial learning of a learning model for driving assistance in step S100, learning of a learning model for evaluation value calculation in step S200, and relearning of the learning model for driving assistance in step S300. Details of each step will be described below.

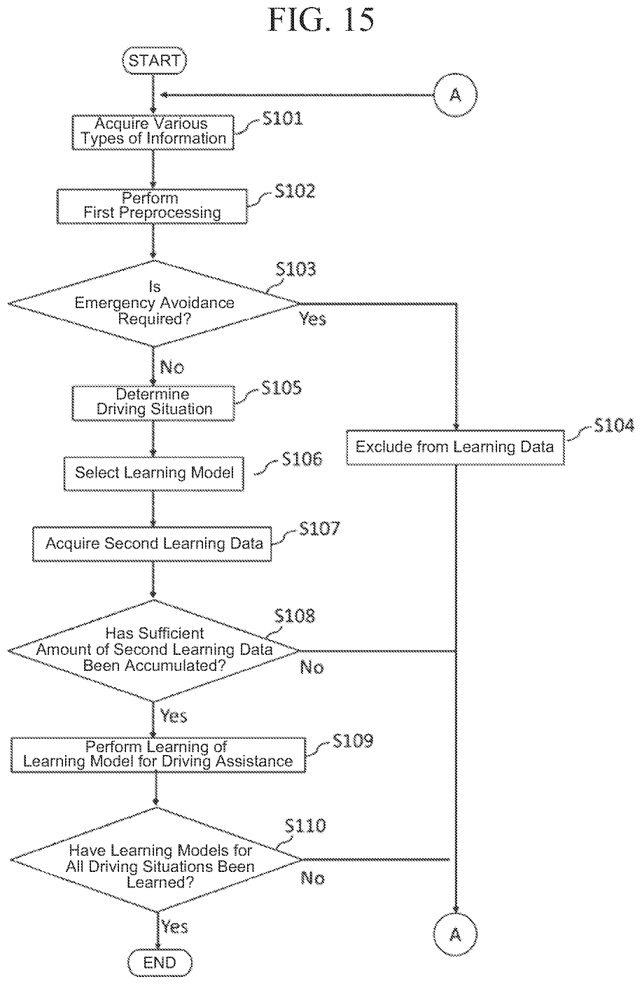

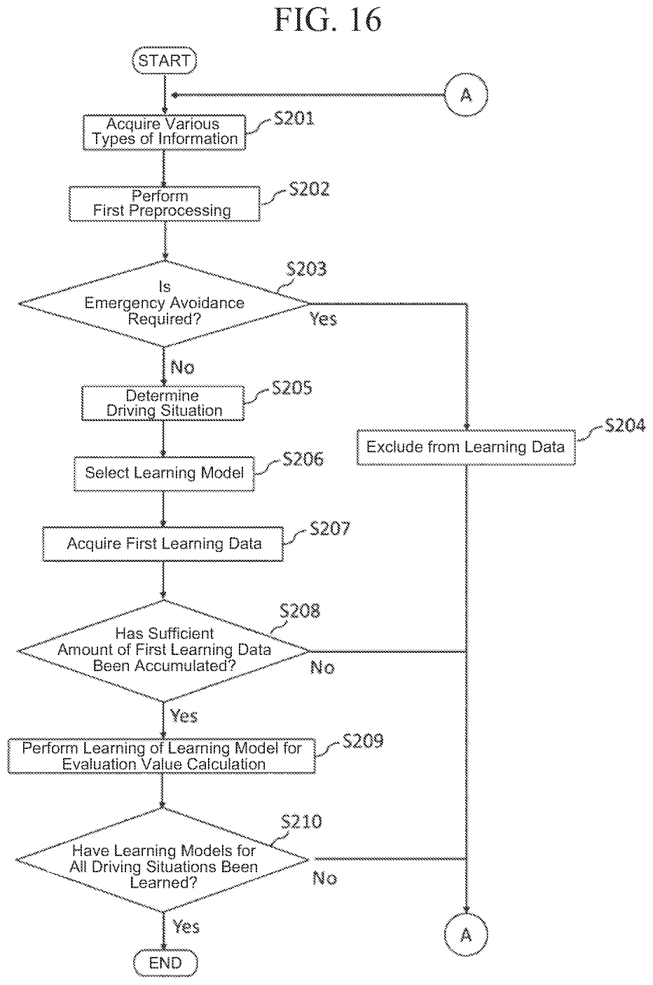

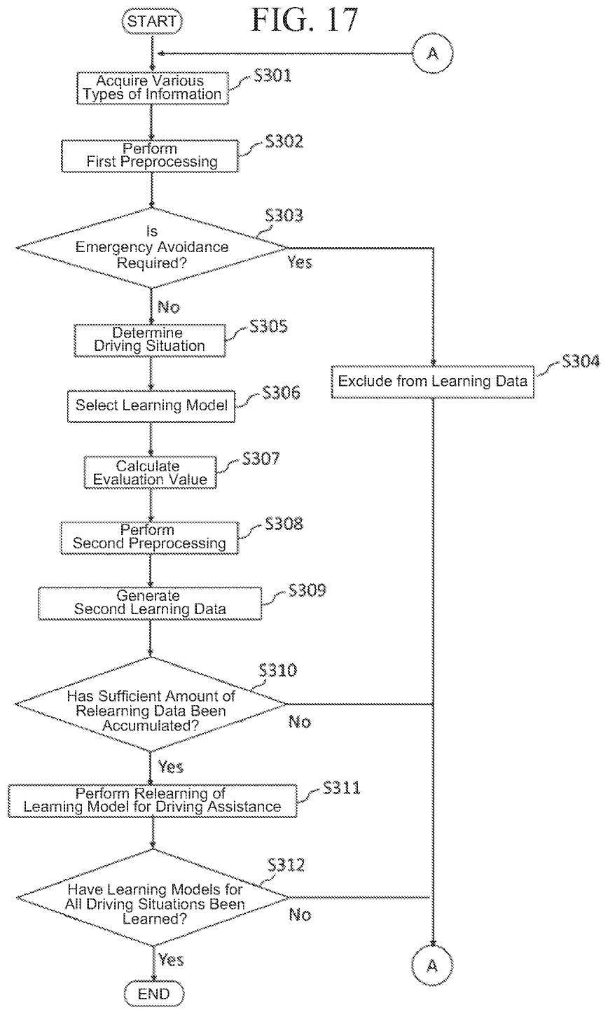

First, details of the initial learning of the learning model for driving assistance in step S100 will be described with reference to FIG. 15. FIG. 15 is a flowchart for explaining the initial learning of the learning model for driving assistance.

First, in step S101, the acquisition unit 310 acquires various types of information including object detection information. More specifically, the object detection information acquiring unit 311 acquires object detection information, the map information acquiring unit 312 acquires map information around a vehicle, the vehicle state information acquiring unit 313 acquires vehicle state information, and the navigation information acquiring unit 314 acquires navigation information.

Next, in step S102, the object detection information acquiring unit 311 performs first preprocessing on the object detection information. The first preprocessing is the same as the preprocessing described in the utilization phase.

Next, in step S103, the emergency avoidance determining unit 321 determines whether or not the vehicle is in a state requiring emergency avoidance by using the object detection information. If the emergency avoidance determining unit 321 determines that the vehicle is in a state requiring emergency avoidance, the process proceeds to step S104, whereas it is determined that the vehicle is not in a state requiring emergency avoidance, the process proceeds to step S105.

If the process proceeds to step S104, the recognition unit 320 excludes the object detection information used for the emergency avoidance determination and the vehicle state information at the same time from the learning data, and returns to step S101.

If the process proceeds to step S105, the driving situation determining unit 322 determines the driving situation of the vehicle.

Next, in step S106, the model selection unit 323 selects a learning model to be used in a subsequent step on the basis of the driving situation determined by the driving situation determining unit 322 in step S105.

Next, in step S107, the second learning data generating unit 332 generates second learning data. The second learning data generated here is learning data for learning the learning model selected in step S106.

Next, in step S108, the learned model for driving assistance generating unit 342 determines whether a sufficient amount of the second learning data has been accumulated. If the learned model for driving assistance generating unit 342 determines that a sufficient amount of the second learning data has not been accumulated, the process returns to step S101, and the acquisition unit 310 acquires various types of information again. On the other hand, if the learned model for driving assistance generating unit 342 determines that a sufficient amount of the second learning data has been accumulated, the process proceeds to step S109.

In step S109, the learned model for driving assistance generating unit 342 learns a learning model for driving assistance. Here, the learned model for driving assistance generating unit 342 learns the learning model selected by the model selection unit 323 in step S106.

Finally, in step S110, the learned model for driving assistance generating unit 342 determines whether learning models for all the driving situations have been learned. If the learned model for driving assistance generating unit 342 determines that there is a learning model that has not yet been learned, the process returns to step S101. On the other hand, if the learned model for driving assistance generating unit 342 determines that the learning models for all the driving situations have been learned, the process of step S100 in FIG. 14 ends.

Next, details of step S200 in FIG. 14 will be described.

Since the processes from step S201 to step S205 are similar to those from step S101 to step S105, the description thereof will be omitted. In addition, in a case where the processing results from steps S101 to S105 are stored in a storage device and the same object detection information is used for learning the learning model for evaluation value calculation, the processes from steps S201 to S205 may be omitted and only the processing results such as the object detection information and a driving situation may be read from the storage device.

In step S206, the model selection unit 323 selects a learning model to be used in a subsequent step on the basis of the driving situation determined by the driving situation determining unit 322 in step S205.

In step S207, the first learning data generating unit 331 generates first learning data. The first learning data generated here is first learning data for learning the learning model selected in step S206. In addition, the first learning data generating unit 331 generates teaching data to be included in the first learning data by using the learned model for driving assistance generated in step S100.

Next, in step S208, the learned model for evaluation value calculation generating unit 341 determines whether a sufficient amount of the first learning data has been accumulated. If the learned model for evaluation value calculation generating unit 341 determines that a sufficient amount of the first learning data has not been accumulated, the process returns to step S201, and the acquisition unit 310 acquires various types of information again. On the other hand, if the learned model for evaluation value calculation generating unit 341 determines that a sufficient amount of the first learning data has been accumulated, the process proceeds to step S209.

In step S209, the learned model for evaluation value calculation generating unit 341 learns a learning model for evaluation value calculation. Here, the learned model for evaluation value calculation generating unit 341 learns the learning model selected by the model selection unit 323 in step S206.

Finally, in step S210, the learned model for evaluation value calculation generating unit 341 determines whether learning models for all the driving situations have been learned. If the learned model for evaluation value calculation generating unit 341 determines that there is a learning model that has not yet been learned, the process returns to step S201. On the other hand, if the learned model for evaluation value calculation generating unit 341 determines that the learning models for all the driving situations have been learned, the process of step S200 in FIG. 14 ends.

Finally, details of step S300 will be described.

The processes from step S301 to step S306 are similar to those from step S101 to step S106. In addition, in a case where the processing results from steps S101 to S106 are stored in a storage device and the same vehicle state information and the same object detection information are used for learning the learned model for driving assistance, the processes from steps S301 to S306 may be omitted and only the processing results such as the vehicle state information, the object detection information and a driving situation stored may be read from the storage device.

In step S307, the evaluation unit 324 calculates the evaluation value of the input object detection information by using the learned model for evaluation value calculation generated in step S200.

In step S308, the second learning data generating unit 332 performs second preprocessing on the input object detection information. The second preprocessing here is the same as the second preprocessing described in the utilization phase.

Next, in step S309, the second learning data generating unit 332 generates second learning data using the object detection information after the second preprocessing. The second learning data at the time of relearning is hereinafter referred to as “relearning data” to be distinguished from the second learning data at the time of initial learning.

Next, in step S310, the learned model for driving assistance generating unit 342 determines whether a sufficient amount of the relearning data has been accumulated. If the learned model for driving assistance generating unit 342 determines that a sufficient amount of the relearning data has not been accumulated, the process returns to step S301, and the acquisition unit 310 acquires the object detection information again. On the other hand, if the learned model for driving assistance generating unit 342 determines that a sufficient amount of the relearning data has been accumulated, the process proceeds to step S311.

In step S311, the learned model for driving assistance generating unit 342 relearns a learning model for driving assistance using the relearning data.

Finally, in step S312, the learned model for driving assistance generating unit 342 determines whether learning models for all the driving situations have been relearned. If the learned model for driving assistance generating unit 342 determines that there is a learning model that has not yet been relearned, the process returns to step S301. On the other hand, if the learned model for driving assistance generating unit 342 determines that the learning models for all the driving situations have been relearned, the process of step S300 in FIG. 14 ends.

With the above operation, the learning device 300 according to the first embodiment can generate the learned model for driving assistance and the learned model for evaluation value calculation.

In addition, in a case where the learning data is generated using object detection information generated by a driving simulator, various obstacles in the real world cannot be reproduced by the driving simulator, a difference occurs between the simulator environment and the real environment, and the inference performance of the learned model may decrease.

In order to solve this problem, the learning device 300 according to the first embodiment performs the second preprocessing in which the sensor value of the object detection information having an evaluation value equal to or less than a predetermined threshold is replaced with the sensor value obtained when the sensor does not detect any object, and the sensor value indicated by the object detection information having an evaluation value greater than the predetermined threshold is maintained at the original sensor value, and relearns the learning model for driving assistance by using the relearning data after the second preprocessing. As a result, by using only the object detection information having a large evaluation value for learning in both the driving simulator and the real environment, it is possible to reduce the difference between the simulator environment and the real environment, and improve the inference accuracy of the learned model.

In addition, since it is difficult for the driving simulator to reproduce the environment outside a preset area, for example, a road on which the vehicle travels, there is a possibility that a difference occurs between the learning data generated by the driving simulator and the object detection information in the real environment.

In order to solve this problem, the learning device 300 according to the first embodiment performs the first preprocessing in which, on the basis of the map information, the sensor value indicated by the object detection information in which the object outside the preset area is detected among the object detection information is replaced with the sensor value obtained when the sensor does not detect any object, and the sensor value indicated by the object detection information in which the object within the preset area is detected is maintained at the original sensor value, and uses the object detection information after the first preprocessing as the learning data. As a result, by ignoring the presence of the object outside the preset area, the object detection information obtained in the simulator environment is equivalent to the object detection information in the real environment. That is, the inference performance of the learned model can be improved by removing information unnecessary for the determination of the learned model.

Modifications of the automated driving system 1000, the driving assistance device 100, and the learning device 300 according to the first embodiment will be described below.

The learned model for driving assistance performs action determination on the basis of the object detection information and the vehicle state information at the current time t, but the driving assistance information may be inferred on the basis of the object detection information and the vehicle state information from the past time t-AT to the current time t. In this case, it is possible to grasp the relative speed relationship between the host vehicle and another vehicle without using the vehicle state information. Similarly, in the learned model for evaluation value calculation, not only the object detection information at the current time t but also the object detection information from the past time t-AT to the current time t may be used as an input. In this case, the evaluation unit 124 and the evaluation unit 324 calculate an evaluation value for each piece of object detection information from the past time t-AT to the current time t.

Although each configuration of the automated driving system 1000 is provided in one vehicle, only the driving assistance device 100 and the vehicle control device 200 may be provided in the vehicle, and the learning device 300 may be implemented by an external server.

Although the case where the driving assistance device 100 and the learning device 300 are applied to the automated driving system 1000 has been described, the driving assistance device 100 and the learning device 300 may be mounted on a manually driven vehicle. In a case where the driving assistance device 100 and the learning device 300 are applied to the manually driven vehicle, for example, it is possible to detect whether the state of the driver is normal or abnormal by comparing the driving assistance information output by the driving assistance device 100 with the driving control actually executed by the driver.

In addition, although the area in which the acquisition unit 110 performs the first preprocessing is set from the outside, the area may be automatically set by the acquisition unit 110 on the basis of navigation information. For example, the inside of the roads on the travel route indicated by the navigation information may be set as the area.

Furthermore, although the driving assistance device 100 divides the driving situation into the state where the emergency avoidance is necessary and the normal driving state and outputs the driving assistance information for each of the states, the driving assistance information may be output without dividing the driving situation by using a learned model. That is, the emergency avoidance determining unit 121 and the emergency avoidance action determining unit 131 do not need to be provided, and the inference unit 132 may also infer driving assistance information necessary for an emergency avoidance action using the learned model for driving assistance by regarding the state where the emergency avoidance is required as one of the driving situations determined by the driving situation determining unit 122.

In addition, the learning device 300 generates a learned model based on each driving situation, and the driving assistance device 100 outputs the driving assistance information by using the learned model based on each driving situation. Therefore, appropriate driving assistance information based on each driving situation can be output. However, in a case where sufficient generalization performance can be obtained, a learned model obtained by collecting a plurality of situations may be used, or a learned model obtained by collecting all driving situations may be used.

Furthermore, the evaluation unit 124 may further use the vehicle state information, the map information, and the navigation information as the input of the learned model for evaluation value calculation. Similarly, the inference unit 132 may further use the map information and the navigation information as the input of the learned model for driving assistance.

In addition, the acquisition unit 110 performs the first preprocessing in step S2, which is immediately after step S1 of acquiring various types of information, but may perform the first preprocessing at any time before step S7 of calculating an evaluation value by the evaluation unit 124. In particular, since the emergency avoidance action requires an immediate response, by performing the first preprocessing after determining the necessity of the emergency avoidance action, it is possible to immediately perform the emergency avoidance action.

Although the learning device 300 has been described as using the same functional model in the initial learning and the relearning of the learning model for driving assistance, different functional models may be used in the initial learning and the relearning. In order to infer the driving assistance information from a large amount of information, it is necessary to perform learning while increasing parameters of a model and the representation ability of the model. However, in a case where inference is performed from a small amount of information, learning can be performed even with a small number of parameters. In the data after the second preprocessing, unnecessary information is removed by replacing a sensor value having a low evaluation value with a predetermined value. As a result, the amount of information in input data is reduced. Therefore, at the time of relearning, even if the learning model for driving assistance is learned with a small model with fewer parameters than the model before relearning, sufficient performance can be obtained. As a result, it is possible to learn with a smaller model with fewer parameters at the time of relearning. By learning the learning model for driving assistance with a smaller model, it is possible to obtain effects of reducing the memory usage and the processing load of an in-vehicle device at the time of inference.

Here, in a case where the model is a neural network, the smaller model is a model in which the number of layers and nodes is reduced.

### INDUSTRIAL APPLICABILITY

The driving assistance device according to the present disclosure is suitable for use in, for example, an automated driving system and a driver abnormality detection system.

### REFERENCE SIGNS LIST

1000: automated driving system, 100: driving assistance device, 200: vehicle control device, 300: learning device, 110, 310: acquisition unit, 120, 320: recognition unit, 130: determination unit, 111, 311: object detection information acquiring unit, 112, 312: map information acquiring unit, 113, 313: vehicle state information acquiring unit, 114, 314: navigation information acquiring unit, 121, 321: emergency avoidance determining unit, 122, 322: driving situation determining unit, 123, 323: model selection unit, 124, 324: evaluation unit, 131: emergency avoidance action determining unit, 132: inference unit, 330: learning data generating unit, 331: first learning data generating unit, 332: second learning data generating unit, 340: learned model generating unit, 341: learned model for evaluation value calculation generating unit, 342: learned model for driving assistance generating unit, 10000, 30000: processing device, 10001, 30001: storage device

1. A driving assistance device comprising:
processing circuitry configured to
acquire object detection information indicating a detection result of an object around a vehicle by a sensor mounted on the vehicle;
output driving assistance information from the input object detection information by using a learned model for driving assistance to infer the driving assistance information for assisting driving of the vehicle from the object detection information;
calculate, as an evaluation value, a degree of influence of the input object detection information on an output of the learned model for driving assistance; and
output the driving assistance information on a basis of the object detection information in which the calculated evaluation value is greater than a predetermined threshold among the input object detection information.

2. The driving assistance device according to claim 1, wherein the processing circuitry further acquires vehicle state information indicating a state of the vehicle, and
outputs the driving assistance information from the vehicle state information and the input object detection information by using the learned model for driving assistance to infer the driving assistance information from the vehicle state information and the object detection information.

3. The driving assistance device according to claim 1, wherein the processing circuitry outputs the evaluation value from the input object detection information by using a learned model for evaluation value calculation to calculate the evaluation value from the object detection information.

4. The driving assistance device according to claim 1, wherein the processing circuitry further acquires map information indicating a position of a feature around the vehicle and specifies the object detection information indicating a detection result of an object within a preset area on a basis of the map information, and
the processing circuitry outputs the driving assistance information on a basis of the specified object detection information.

5. The driving assistance device according to claim 4, wherein the processing circuitry performs first preprocessing to replace a sensor value of the object detection information indicating a detection result of an object outside a preset area with a predetermined sensor value on a basis of the map information and outputs the object detection information after the first preprocessing.

6. The driving assistance device according to claim 5, wherein the processing circuitry performs, as the first preprocessing, processing to set a sensor value of the object detection information indicating the detection result of the object outside the preset area as a sensor value obtained when the sensor does not detect any object.

7. The driving assistance device according to claim 5, wherein the processing circuitry performs, as the first preprocessing, processing to replace the sensor value of the object detection information indicating the detection result of the object outside the preset area with a predetermined sensor value and to maintain the sensor value of the object detection information indicating the detection result of the object within the preset area at an original sensor value on a basis of the map information.

8. The driving assistance device according to claim 1, wherein the processing circuitry performs second preprocessing to replace a sensor value of the object detection information having the evaluation value equal to or less than a predetermined threshold among the input object detection information with a predetermined sensor value, inputs the object detection information after the second preprocessing to the learned model for driving assistance, and outputs the driving assistance information.

9. The driving assistance device according to claim 8, wherein the processing circuitry performs, as the second preprocessing, processing to replace the sensor value of the object detection information having the evaluation value equal to or less than a predetermined threshold among the input object detection information with a sensor value obtained when the sensor does not detect any object.

10. The driving assistance device according to claim 8, wherein the processing circuitry performs, as the second preprocessing, processing to replace the sensor value of the object detection information having the evaluation value equal to or less than the predetermined threshold with the predetermined sensor value and to maintain a sensor value of the object detection information having the evaluation value greater than the predetermined threshold at an original sensor value.

11. A learning device comprising:
processing circuitry configured to
generate first learning data including object detection information indicating a detection result of an object around a vehicle by a sensor mounted on the vehicle and an evaluation value indicating a degree of influence of the object detection information on an output of a learned model for driving assistance to infer driving assistance information for assisting driving of the vehicle; and
generate a learned model for evaluation value calculation to calculate the evaluation value from the object detection information by using the first learning data.

12. A learning device comprising:
processing circuitry configured to
generate second learning data including object detection information indicating a detection result of an object around a vehicle by a sensor mounted on the vehicle and driving assistance information for assisting driving of the vehicle;
generate a learned model for driving assistance to infer the driving assistance information from the object detection information by using the second learning data;
calculate, as an evaluation value, a degree of influence of the object detection information included in the input second learning data on an output of the learned model for driving assistance; and
generate the learned model for driving assistance by using the second learning data including the object detection information in which the calculated evaluation value is greater than a predetermined threshold among the input second learning data.

13. A driving assistance method used in a driving assistance device, comprising:
acquiring object detection information indicating a detection result of an object around a vehicle by a sensor mounted on the vehicle;
outputting driving assistance information from the input object detection information by using a learned model for driving assistance to infer the driving assistance information for assisting driving of the vehicle from the object detection information;
calculating, as an evaluation value, a degree of influence of the object detection information input on an output of the learned model for driving assistance; and
outputting the driving assistance information on a basis of the object detection information in which the evaluation value calculated in the evaluation step is greater than a predetermined threshold among the object detection information input.

14. A non-transitory computer readable medium with an executable a driving assistance program stored thereon wherein the program instructs a computer to perform:
acquiring object detection information indicating a detection result of an object around a vehicle by a sensor mounted on the vehicle;
outputting driving assistance information from the input object detection information by using a learned model for driving assistance to infer the driving assistance information for assisting driving of the vehicle from the object detection information;
calculating as an evaluation value, a degree of influence of the object detection information input on an output of the learned model for driving assistance; and
outputting the driving assistance information on a basis of the object detection information in which the evaluation value calculated in the evaluation step is greater than a predetermined threshold among the object detection information input.

15. A learned model generation method used in a learning device, comprising:
generating first learning data including object detection information indicating a detection result of an object around a vehicle by a sensor mounted on the vehicle and an evaluation value indicating a degree of influence of the object detection information on an output of a learned model for driving assistance to infer driving assistance information for assisting driving of the vehicle; and
generating a learned model for evaluation value calculation to calculate the evaluation value from the object detection information by using the first learning data.

16. A non-transitory computer readable medium with an executable a learned model generation program wherein the program instructs a computer to perform:
generating first learning data including object detection information indicating a detection result of an object around a vehicle by a sensor mounted on the vehicle and an evaluation value indicating a degree of influence of the object detection information on an output of a learned model for driving assistance to infer driving assistance information for assisting driving of the vehicle; and
generating a learned model for evaluation value calculation to calculate the evaluation value from the object detection information by using the first learning data.

17. A learned model generation method used in a learning device, comprising:
generating second learning data including object detection information indicating a detection result of an object around the vehicle by a sensor mounted on the vehicle and driving assistance information for assisting driving of the vehicle;
generating a learned model for driving assistance to infer the driving assistance information from the object detection information by using the second learning data;
calculating, as an evaluation value, a degree of influence of the object detection information included in the input second learning data on an output of the learned model for driving assistance; and
generating the learned model for driving assistance by using the second learning data including the object detection information in which the calculated evaluation value is greater than a predetermined threshold among the input second learning data.

18. A non-transitory computer readable medium with an executable a learned model generation program wherein the program instructs a computer to perform:
generating second learning data including object detection information indicating a detection result of an object around the vehicle by a sensor mounted on the vehicle and driving assistance information for assisting driving of the vehicle;
generating a learned model for driving assistance to infer the driving assistance information from the object detection information by using the second learning data;
calculating, as an evaluation value, a degree of influence of the object detection information included in the input second learning data on an output of the learned model for driving assistance; and
generating the learned model for driving assistance by using the second learning data including the object detection information in which the calculated evaluation value is greater than a predetermined threshold among the input second learning data.
